(19) United States
(12) Patent Application Publication
(10) Pub. No.: US 2026/0203782 A1
(43) Pub. Date: Jul. 16, 2026

(54) PERSONAL GIVING IDENTITY ASSESSMENT

(71) Applicant: Age of Generosity, LLC, Atlanta, GA (US)

(72) Inventor: Christopher C. Gabriel, Atlanta, GA (US)

(21) Appl. No.: 19/444,972

(22) Filed: Jan. 9, 2026

Related U.S. Application Data
(60) Provisional application No. 63/743,878, filed on Jan. 10, 2025.

(51) Int. Cl. G06Q 30/0203

(52) U.S. Cl. CPC G06Q 30/0203

(57) ABSTRACT

The present disclosure presents systems and methods for personal giving identity assessment. One such method comprises generating, by a computing device, a graphical user interface of queries and response options for each of the queries for a user, wherein response values for the response options are embedded within the graphical user interface, wherein the response values comprises values across components of a plurality of dimensions of a personal giving identity type; receiving, by the computing device, selections for the response options from the user; generating, by the computing device, a response string of selected response values based on the received response options and the embedded response values; processing, by the computing device, the response string of selected response values to compute the personal giving identity type for the user; and/or instantly displaying, by the computing device, the personal giving identity type to the user.

### CROSS-REFERENCE TO RELATED APPLICATION

This application claims priority to co-pending U.S. provisional application entitled, “Personal Giving Identity (PGI) Assessment,” having application number 63/743,878, filed Jan. 10, 2025, which is entirely incorporated herein by reference.

### BACKGROUND

Assessment tools can be used by individuals to identify characteristics in themselves or others. In the context of charitable donations (or other types of personal giving), assessments have been used to identify a financial capacity an individual has to make giving contributions or donations to a particular cause or causes. But there is no tool available to identify the types of causes that will be meaningful to a particular individual. Such a tool could also be used to determine the priorities and preferences that an individual has with respect to their giving efforts. This information would be useful to not only the individual but also a financial advisor or fundraiser who may be provided the information in consultation with the individual. However, there are technical challenges to providing software features that can achieve these goals in an intelligent, dynamic, and computationally efficient manner, such as providing evaluation results in real-time.

### SUMMARY

Embodiments of the present disclosure provide personal giving identity assessment systems and methods. Briefly described, in architecture, one embodiment of the system, among others, comprises a processor of a computing device; and a memory in communication with the processor, the memory storing program instructions, the processor operative with the program instructions to perform the operations of: generate a graphical user interface of queries and response options for each of the queries for a user, wherein response values for the response options are embedded within the graphical user interface, wherein the response values comprises values across components of a plurality of dimensions of a personal giving identity type; receive selections for the response options from the user; generate a response string of selected response values based on the received response options and the embedded response values; process the response string of selected response values to compute the personal giving identity type for the user; and/or instantly display the personal giving identity type to the user.

The present disclosure can also be viewed as providing personal giving identity assessment methods. In this regard, one embodiment of such a method, among others, comprises generating, by a computing device, a graphical user interface of queries and response options for each of the queries for a user, wherein response values for the response options are embedded within the graphical user interface, wherein the response values comprises values across components of a plurality of dimensions of a personal giving identity type; receiving, by the computing device, selections for the response options from the user; generating, by the computing device, a response string of selected response values based on the received response options and the embedded response values; processing, by the computing device, the response string of selected response values to compute the personal giving identity type for the user; and/or instantly displaying, by the computing device, the personal giving identity type to the user.

The present disclosure can also be viewed as providing non-transitory computer readable mediums comprising machine readable instructions that, when executed by a processor of a computing device, cause the computing device to at least: generate a graphical user interface of queries and response options for each of the queries for a user, wherein response values for the response options are embedded within the graphical user interface, wherein the response values comprises values across components of a plurality of dimensions of a personal giving identity type; receive selections for the response options from the user; generate a response string of selected response values based on the received response options and the embedded response values; process the response string of selected response values to compute the personal giving identity type for the user; and/or instantly display the personal giving identity type to the user.

In one or more aspects for such systems, methods, and mediums, the personal giving identity type is displayed as part of a user-specific personal giving report on a web page or software user interface, the plurality of dimensions comprise a generosity personality type, a generosity expression type, a generosity driver type, and a generosity motivation type, each of the plurality of dimensions are composed of individual components, wherein the individual components for the generosity personality type comprises focused giving, expressive giving, disciplined giving, and considerate giving components, the individual components for the generosity expression type include people-helping and problem-solving components, the individual components for the generosity driver type include intuitive and analytic components, the individual components for the generosity motivation type include compulsion, connection, conviction, and compassion components, the embedded response values include a tiebreaker code for selecting between individual components that have the same point totals or have point totals within a defined threshold, at least one individual response value comprises values across a plurality of individual components of the same dimension, and/or the queries consist of 22 queries.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 illustrates a flow chart of a process for identifying personal giving characteristics of an individual, in accordance with embodiments of the present disclosure.

FIG. 2 illustrates an exemplary user interface for presenting an input query according to various embodiments of the present disclosure.

FIGS. 3A-3D illustrate exemplary personal giving identity metrics that can be included in the individual queries of the present disclosure, in accordance with various embodiments of the present disclosure.

FIG. 4 illustrates an exemplary web page or software interface for a user-specific personal giving report, in accordance with various embodiments of the present disclosure.

FIG. 5 shows a schematic block diagram of a computing device that can be used to implement various embodiments of the present disclosure.

FIG. 6 illustrates an exemplary user interface that displays hidden response values according to various embodiments of the present disclosure.

FIG. 7A illustrates an exemplary user interface for presenting an input query according to various embodiments of the present disclosure.

FIG. 7B illustrates an exemplary user interface that displays hidden response values according to various embodiments of the present disclosure.

FIG. 8A illustrates an exemplary user interface for presenting an input query according to various embodiments of the present disclosure.

FIG. 8B illustrates an exemplary user interface that displays hidden response values according to various embodiments of the present disclosure.

### DETAILED DESCRIPTION

This disclosure relates generally to systems and methods for an analytic framework for producing common reference points or components across a plurality of personal giving dimensions and identifying personal giving characteristics of an individual based on specific scores across the plurality of dimensions. Accordingly, in various embodiments, systems and methods of the present disclosure (e.g., personal giving identity systems and methods) can identify priorities and preferences of an individual when it comes to personal financial giving across four different dimensions in real-time based on a small set of queries that are structured as a web page or software interface having hidden coding for structuring query responses for immediate attribution of giving qualities towards the individual. Accordingly, after query response are received for all of the input queries, systems and methods of the present disclosure are enabled to instantly compute, identify, and communicate (e.g., within the same session) characteristics of the individual across the four different dimensions of a personal giving spectrum based on how response values are embedded in the graphical user interface, which provides benefits more efficient handling of computations for identifying a user-specific personal giving identity type on-the-fly. Accordingly, systems and methods of the present disclosure provide improved performance due to the integrated structure over conventional approaches.

Following below are more detailed descriptions of various concepts related to, and embodiments of, techniques for computing an individual's overall personal giving identity in terms of a generosity personality type, a generosity expression type, a generosity driver type, and a generosity motivation type (and their individual components). It should be appreciated that various aspects described herein may be implemented in any of numerous ways. Examples of specific implementations are provided herein for illustrative purposes only. In addition, the various aspects described in the embodiments below may be used alone or in any combination and are not limited to the combinations explicitly described herein.

To begin, generosity can be viewed as a common thread that ties important elements of one's life. For example, generosity can define one's role in their relationships, can give purpose to one's professional work, can be a focus of spiritual goals, and can be the heart of one's community services. Thus, in accordance with various embodiments of the present disclosure, the four dimensions upon which an individual is scored comprise a generosity personality type, a generosity expression type, a generosity driver type, and a generosity motivation type. The spectrum of options for the generosity personality type include focused, expressive, considerate, or disciplined components. The spectrum of options for the generosity expression type include people-helping (charitable) and problem-solving (philanthropic). The spectrum of options for the generosity driver type include intuitive (emotional focus) and analytic (intellectual focus) components. The spectrum of options for the generosity motivation type include compulsion, connection, conviction, and compassion components. Each combination of these various components produces an individual's overall personal giving identity.

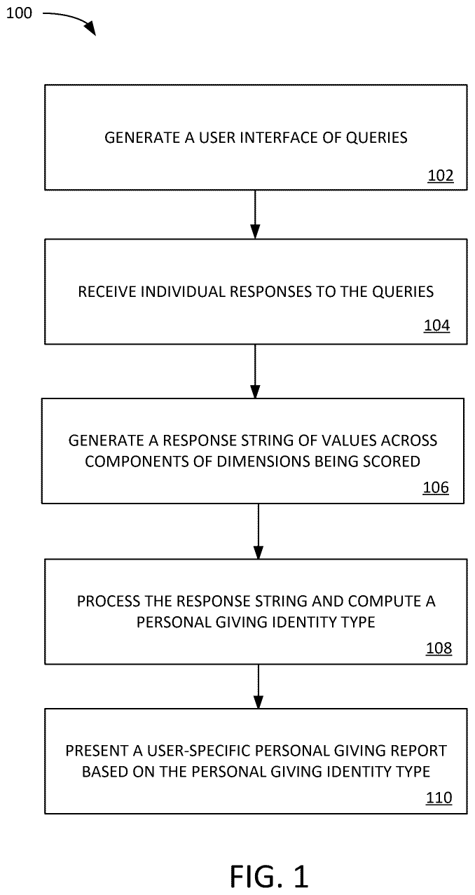

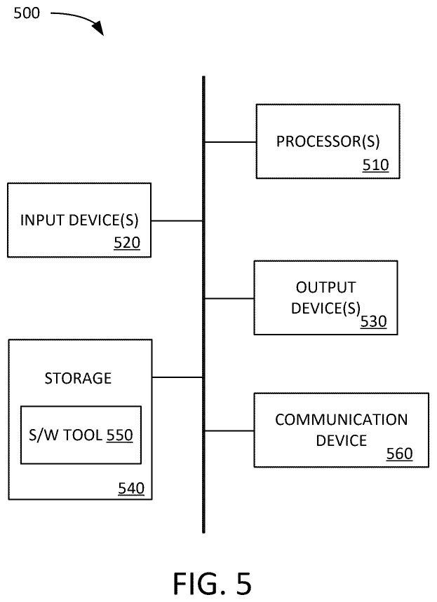

FIG. 1 illustrates a flow chart of a process 100 for identifying personal giving characteristics of an individual, in accordance with embodiments of the present disclosure. Process 100 is performed, for example, using one or more computing devices 500 (FIG. 5) implementing a software platform or tool 550 (FIG. 5). In some examples, process 100 is performed using a client-server system, and the blocks of process 100 are divided up in any manner between the server and a client device. In other examples, the blocks of process 100 are divided up between the server and multiple client devices. In other examples, process 100 is performed using only a client device or only multiple client devices. In process 100, some blocks are, optionally, combined, the order of some blocks is, optionally, changed, and some blocks are, optionally, omitted. In some examples, additional steps may be performed in combination with the process 100. Accordingly, the operations as illustrated (and described in greater detail below) are exemplary by nature and, as such, should not be viewed as limiting.

At block 102 of FIG. 1, the system generates a graphical user interface, such as a web page or software interface of a software tool 550 (FIG. 5), of queries directed to a user. For example, in order to learn more about an individual's priorities and preferences when it comes to personal giving, a financial adviser may send a URL (uniform resource locator) link to the user, where a web page associated with the URL can be branded with information on the individual or an organization of the individual (e.g., organization logo) in addition to a series of queries intended for the user. In various embodiments, the queries can be multiple choice type questions and answers that are intended to be completed in a short amount of time (e.g., 22 multiple choice questions that can be completed within 5 minutes). Each of the responses to the questions is designed to contribute point values to one or more of the components across the plurality dimensions being evaluated for the individual, where available point values are embedded in the graphical user interface and are readily available for processing to determine an overall personal giving identity type of the user. For example, a response to a particular question may contribute toward an individual's components directed to their expressive-ness (as part of determining their personality type), problem-solving-ness (as part of determining their generosity type), analytic-ness (as part of determining their driver type), and conviction-ness (as part of determining their motivation type). Further, different responses may be weighed more heavily in point values than other responses.

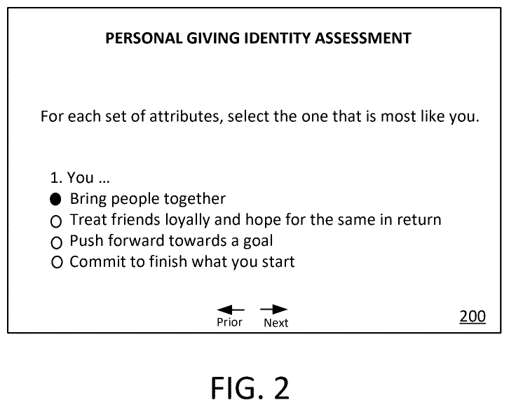

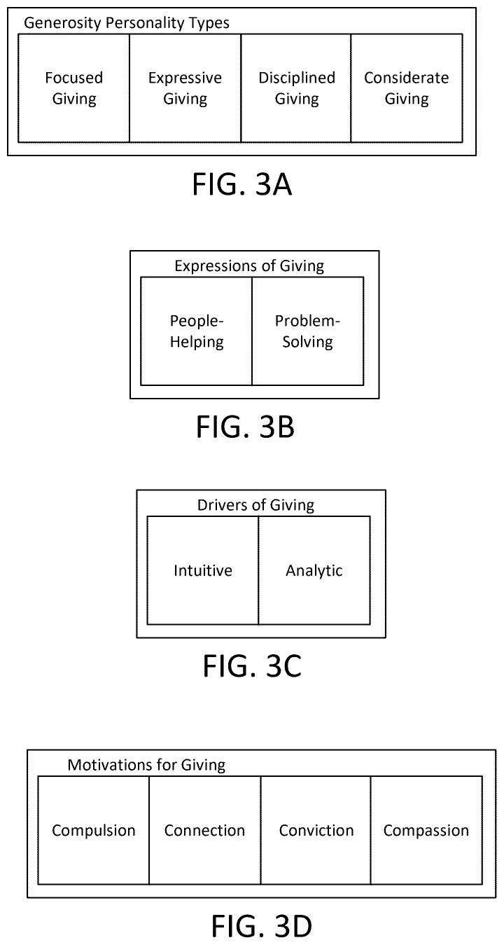

FIG. 2 illustrates an exemplary user interface 200 according to embodiments of this disclosure. In one or more examples, user interface 200 may be used to access and present a list of input queries as well as the results, i.e., the user-specific personal giving report. FIGS. 3A-3D illustrate the exemplary personal giving identity metrics that can be included in the individual queries, in certain embodiments. The list of input queries comprises a personal assessment questionnaire related to personal metric categories of a (1) generosity preference type and preferences for focused giving, expressive giving, disciplined giving, or considerate giving, as shown in FIG. 3A; (2) expressions of giving and preferences for people-helping (charity) (e.g., giving to people you do not know) or problem solving (philanthropy) (e.g., giving to causes), as shown in FIG. 3B; (3) drivers of giving and characteristics for being intuitive (heart or emotional giving) or analytic (head or intellectual giving), as shown in FIG. 3C; and (4) motivations for giving and characteristics for being motivated by compulsion, connection, conviction, or compassion, as shown in FIG. 3D.

Accordingly, in various embodiments, for each query response to be selected by the user in the graphical user interface, the query response is structured to have a hidden embedded field whose value is the concatenation of point values across the plurality of components of dimensions being scored for the individual (e.g., such as whether a response indicates that the user is possibly motivated by conviction, the user likes to give for problem solving causes, etc.).

Referring back to FIG. 1, at blocks 104-106, the system can receive individual responses to the queries presented in block 102 and generate, based on the plurality of responses, a response string of the values across the plurality of components of dimensions being scored that are associated with the selected responses. In various embodiments, the response string may also include tiebreaker codes for selecting between components that have the same point totals or within a defined threshold (e.g., the point totals only have a 1 point difference). From the response string, the system can compute and identify the individual components of the personal giving identity type that is associated with the user.

Accordingly, in block 108, a client-side or server-side process processes the response string to generate a total point value across the plurality of components of dimensions from the concatenation of the values for all the selected responses in order to compute a personal giving identity type for the user, where the type is a combination of the plurality of personal giving dimensions.

Thus, the computed personal giving identity type (and related components) can then be used to generate a user-specific personal giving report. Accordingly, at block 110 of FIG. 1, the system can display a user interface for presenting the user-specific personal giving report based on the determined personal giving identity type. In various embodiments, basic results of the personal giving report (e.g., identification of the personal giving identity type and brief explanation) may be instantly presented as a web page or software user interface after the user completes responding to the initial queries and a more detailed report may be emailed to the user or may be made available for download from the web page or software user interface. Further, an advisor to the user (e.g., financial adviser, fundraiser, attorney, accountant, wealth manager, etc.) who is also a user of the system may be provided a copy of the personal giving report. Alternatively, or in addition to, a report tailored to the advisor may be generated and provided, such as one that includes sample discussion questions for the fundraiser or advisor about how to talk with the individual about their giving in a way that aligns with their personal giving identity type. For example, in certain scenarios, during a meeting with a prospective donor, a fundraiser may have the donor interact and provide responses to the queries presented by the graphical user interface of the disclosed system/method and then be provided in real time information on the personal giving identity type of the individual along with sample discussion topics or questions to help in conducting the meeting in a productive manner. Additionally, in a scenario where an advisor or fundraiser is meeting with a group of individuals (e.g., a married couple, board of directors, etc.), the individuals may provide responses to the queries and the advisor/fundraiser may be provided information on how the individuals align or do not align with respect to their personal giving objectives based on their assigned personal giving identities.

In one or more embodiments, the user-specific personal giving report can be tailored for a particular individual or group. For example, in some embodiments, the user-specific personal giving report can be designed to seamlessly integrate with an individual's or groups' brand by, for example, but limited to, adopting the fonts, colors, graphics, and graphical designs associated with a particular individual, group, association, or company.

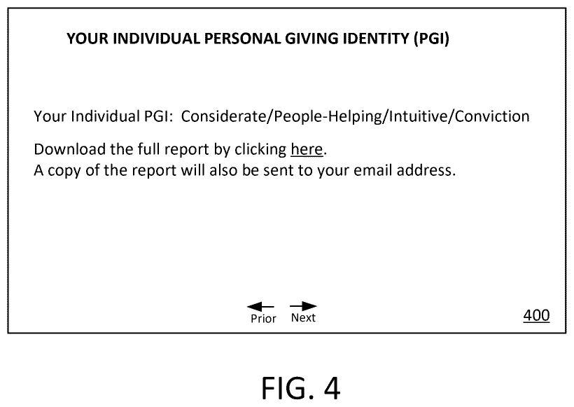

FIG. 4 illustrates an exemplary web page or software interface 400 for a user-specific personal giving report. As shown in the figure, the user-specific personal giving report can include a summary of the results of the personal giving identity assessment. In one or more examples, the summary of the results can include a visual representation of the personal giving identity components as well as descriptive content summarizing the individual components. The report can further include additional explanatory pages related to explaining and/or summarizing the contents of the report and how the report may be used by the individual.

FIG. 5 illustrates an example of a computing device 500 that may be used in a system implementing techniques described herein, although others are possible. It should be appreciated that FIG. 5 is intended neither to be a depiction of necessary components for a computing device to operate as personal giving identity system in accordance with the principles described herein, nor a comprehensive depiction.

For example, the device 500 can be used to perform process 100, described above. Device 500 can be a host computer connected to a computer network. Device 500 can be a client computer or a server. As shown in FIG. 5, device 500 can be any suitable type of microprocessor-based device, such as a personal computer, workstation, server or handheld computing device (portable electronic device) such as a phone or tablet. The device can include, for example, one or more of processor 510, input device 520, output device 530, storage 540, and communication device 560. Input device 520 and output device 530 can generally correspond to those described above, and can either be connectable or integrated with the computer.

Input device 520 can be any suitable device that provides input, such as a touch screen, keyboard or keypad, mouse, or voice-recognition device. Output device 530 can be any suitable device that provides output, such as a touch screen, haptics device, or speaker.

Storage 540 can be any suitable device that provides storage, such as an electrical, magnetic or optical memory including a RAM, cache, hard drive, or removable storage disk. Communication device 560 can include any suitable device capable of transmitting and receiving signals over a network, such as a network interface chip or device. The components of the computer can be connected in any suitable manner, such as via a physical bus or wirelessly.

Software tool 550, which can be stored in storage 540 and executed by processor 510, can include, for example, the programming that embodies the functionality of the present disclosure (e.g., as embodied in the devices as described above). Other software programs may also be stored in storage, such as an operating system.

Software tool 550 (and other software programs) can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 540, that can contain or store programming for use by or in connection with an instruction execution system, apparatus, or device.

Software tool 550 (and other software programs) can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

Device 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 500 can implement any operating system suitable for operating on the network. Software tool 550 can be written in any suitable programming language, such as C, C++, Java or Python. In various embodiments, application software embodying the functionality of the present disclosure can be deployed in different configurations, such as in a client/server arrangement or through a Web browser as a Web-based application or Web service, for example.

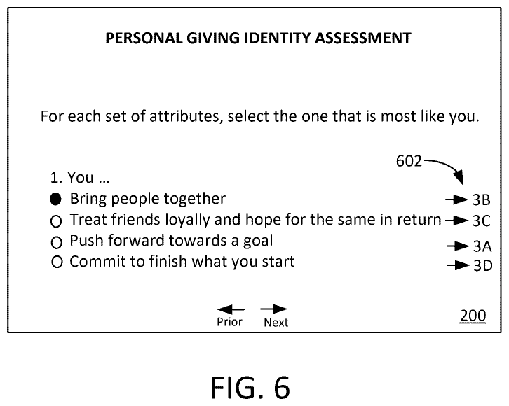

With respect to the present disclosure, software tool 550 can be designed and configured to identify personal giving characteristics of an individual (as discussed with respect to FIG. 1. Accordingly, the software tool 550 can generate reports shared with authorized program users. In various embodiments, the outputs are confidential and viewable both online and through downloadable PDF (portable document format) documents. To do so, the software tool 550 is configured to display a graphical user interface having a series of queries and possible response for selection by a user. Each query is designed to contribute a point value towards one or more of the personal giving identity components being scored and computed by the software logic. For example, FIG. 2 shows an exemplary input query that can be presented to a user in a graphical user interface 200, where the user is prompted to complete the statement “1. You . . . ” with one of the following possible responses: “Bring people together,” “Treat friends loyally and hope for the same in return,” “Push forward towards a goal,” and “Commit to finishing what you start” by selecting a graphical interface control, such as a radio or option button. Based on the user's response to this query, the software tool 550 is configured to append a hidden response value associated with the response to a response string. For example, FIG. 6 shows the hidden response values 602 for each of the possible responses that are embedded as metadata in the graphical user interface code, and are not visible to non-administrative users, in accordance with an exemplary non-limiting scoring ruleset. Accordingly, the type of user interface shown in FIG. 6 may be viewable by an administrative user. In various embodiments, the response values may be expressed as filter hooks in WordPress electronic form documents, among others.

In the exemplary ruleset, 12 different components of the personal giving identity metric are mapped to A-L letters, as follows: A=Focused, B=Expressive, C=Considerate, D=Disciplined, E=Analytic, F=Intuitive, G=People-Helping, H=Problem-Solving, I=Compulsion, J=Connection, K=Conviction, and L=Compassion, that are encoded as response values. Thus, each response option is assigned a value consisting of a number or an asterisk followed by uppercase letters A-L representing the identity component types. The numbers are points assigned to the individual query responses for the component type represented by the assigned letter. Thus, a response with the value 3A (as provided in the first response option in FIG. 6B), translates to +3 points to the Focused component score for the user.

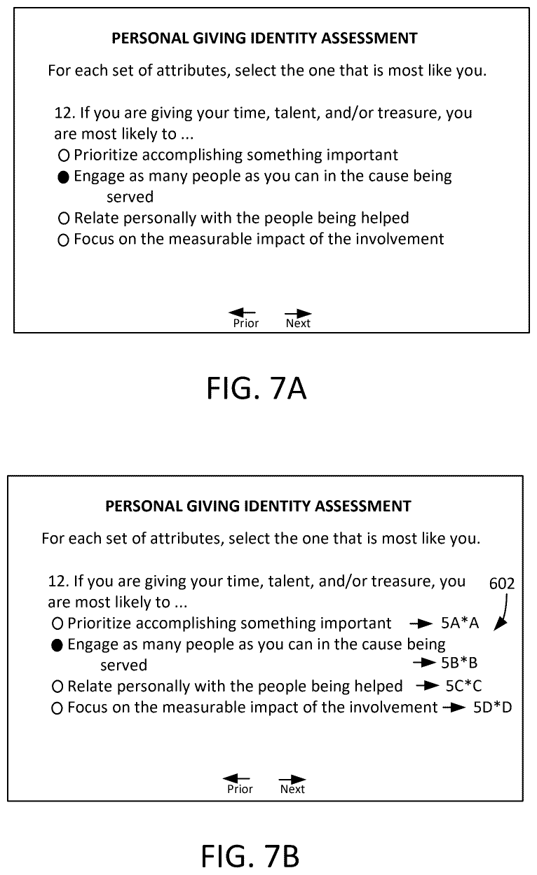

In the foregoing example, the ruleset also specifies that the existence of an asterisk in the response values denotes a tie-breaking response or a special condition. For example, FIG. 7A shows an exemplary query asking the user to complete the statement, “If you are giving your time, talent, and/or treasure, you are most likely to . . . ” by selecting one of the following responses: “Prioritize accomplishing something important,” “Engage as many people as you can in the cause being served,” “Relate personally with the people being helped,” and “Focus on the measurable impact of the involvement.” Correspondingly, FIG. 7B shows the hidden response values 602 associated with each of the response options. In the case of the first response option, the point value is “5A*A” indicates that +5 points is added to the score for the Focused component and an additional 1 point will be added to the Focused component score in case that of a tiebreaker being needed (where A is interpreted as being equivalent to 1A) to break a tie between a Focused component and another component of the generosity personality type. Additionally, the ruleset may specify a special condition that is triggered by inclusion of an asterisk in a response option value, such as automatically attributing a component type to a user if a certain condition is satisfied by a user's selected responses, such as a user selecting a third response option in a threshold number of responses or a specific combination of query responses.

Further, in a non-limiting example, a response option having a value containing a lowercase letter is only used for tiebreaker scenarios,. For example, a response option containing the hidden value 2j would yield +2 points to the Connection motivation component if there was a tie been a score for the Connection motivation component and another one of the motivation components.

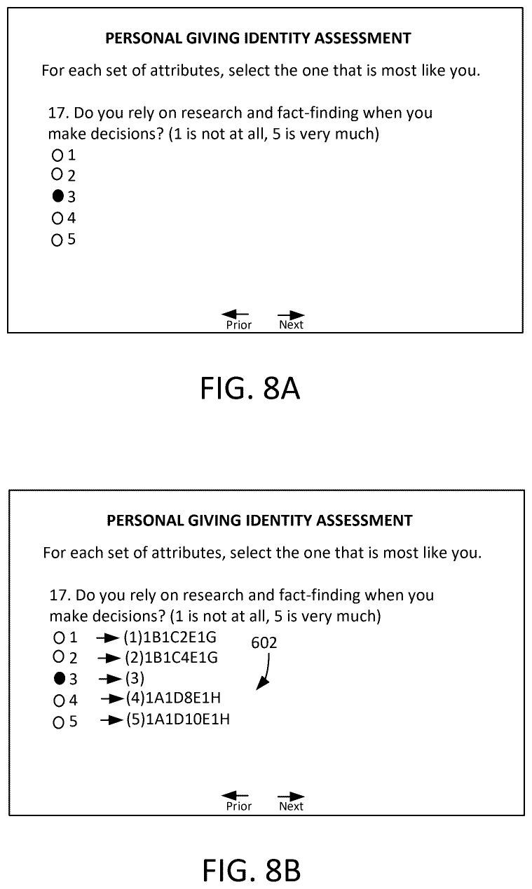

While the examples of FIGS. 6 and 7B shows response options having singular component attributions, FIG. 8A shows an exemplary query asking the user to complete the statement, “Do you rely on research and fact-finding when you make decisions?” by selecting one of the following responses: 1, 2, 3, 4, or 5 (where 1 indicates no factor and 5 indicates a strong factor across the spectrum of 1 to 5). Correspondingly, FIG. 8B shows the hidden response values associated with each of the response options. In the case of the first response option, the point value is 1B1C2E1G, which indicates that +1 points is added to the score for the Expressive component, +1 point is added to the score for the Considerate component, 2 points is added to the score for the Analytic component, and 1 point is added to the People-Helping component. In this way, a small number of queries (e.g., 22 questions) is sufficient to determine a user's personal giving identity across four dimensions, that are combined to identify the user-specific personal giving identity type.

In various embodiments, a prefix is added in parentheses before the value string to help indicate which response option is associated with the particular value string. In this case, this string value is associated with the first response option (“1”) for this particular query, and consequently, a “(1)” is used at the beginning of the string, as follows and shown in FIG. 8B: (1)1B1C2E1G. Likewise, the response string value for the second response option (“2”) begins with (2) and is as follows: (2)1B1C4E1G, where the value in the parenthesis is not used to compute the scores for personal identity giving and is merely provided as way to debug or proof provided responses, as necessary, (e.g., to help with debugging and ensuring there are no empty or repeated values), such as “people” or “statistics.”

Accordingly, parentheticals may not be used in certain embodiments or may not be used for response options not having complicated response string values, like in FIGS. 6 and 7B. Further, in instances where a response option is not a number and is a word or a phrase, then the word or an initial word in the phrase may be included in the parenthetical expression at the start of the response string.

Also, as shown in FIG. 8B, in some instances a selected response option may be intentionally assigned a zero or an empty value. For example, the third response option is assigned a value of “(3)” which indicates that no component scores are to be updated and adjusted if a user selects the third response option for this question.

After responses for all of the queries have been selected by a user, the computing device 500 generates a response string of the values associated with the selected responses. For example, in a non-limiting illustration, the following response string may be generated from responses for 22 queries: 3A3C3C3C3D3C5A*A(4)1A1D8E1H(3)6F(5)1A1B1F1G(people)1B1C1F5G*F*G(statisti cs)1A1D1E5H(brought)1B1C1G1I1J(4)1I1J1i(2)1I(5)1J2K1L1k(4)1J1K1L(3)*J(2)1F1G1I1J(4)1B1C1F1G1J1K1L1I(2)1I1J(4)1J1K1, where the format of the response string is in the form: [response value for query 1][response value for query 2] . . . [response value for query 22]. Accordingly, the computing device 500 can process the response string code to determine the user's personal giving identity type, since the values for personality, driver, expression, and motivation components can be determined from the response string. In various embodiments, the response string can be computed by a client computing device or can be submitted to a server computing device from a client computing device and processed at the server computing device. In an exemplary embodiment, in processing the response string, the computing device 500 tallies up instances of the individual personal giving personality components, such as instances of A (Focused), B (Expressive), C (Considerate), D (Disciplined) in the [responses] string. If there is a tie in the computations, then tie-breaking code is processed, such as *A→Focused, *B→Expressive, *C→Considerate, *D→Disciplined. Thus, for the example response string 3A3C3C3C3D3C5A*A(4)1A1D8E1H(3)6F(5)1A1B1F1G(people)1B1C 1F5G*F*G (statistics)1A1D1E5H(brought)1B1C1G1I1J(4)1I1J1i(2)1I(5)1J2K1L1k(4)1J 1K1L(3)*J(2)1F1G1I1J(4)1B1C1F1G1J1K1L1I(2)1I1J(4)1J1K1L, the resulting tally for the personal giving identity components for A, B, C, and D are A: 11; B: 4; C: 15; and D: 5, resulting in the user being determined to be associated with C (Considerate) identity type. In various embodiments, processing of the response string involves using regular expression matches to tally up the various types. For example, in various embodiments, the regular expression used for A is /(\d+)A/, with the numbers being captured and then added up to get 11. If there is a tie, a regular expression match is performed with the following pattern: ∧*([ABCD])/ so that this time the winning type is captured.

Likewise, processing of the response string to determine the driver type of the user involves tallying up the instances of E (Analytic) and F (Intuitive) component values in the [responses] string. If there is a tie (or difference is +/−1), tie-breaking code is also processed: *E→Analytic, *F→Intuitive. Thus, for the example response string 3A3C3C3C3D3C5A*A(4)1A1D8E1H(3)6F(5)1A1B1F1G(people)1B1C1F5G*F*G(statisti cs)1A1D1E5H(brought)1B1C1G1I1J(4)1I1J1i(2)1I(5)1J2K1L1k(4)1J1K1L(3)*J(2)1F1G1I1J(4)1B1C1F1G1J1K1L1I(2)1I1J(4)1J1K1L, the resulting tally is 9 for E and 10 for F. To process the response string, regular expression matching may be used to tally the component values. For example, in certain embodiments, the regular expression used for E is /(\d+)E/, with the numbers being captured and then added up, results in a point value of 9.

In certain instances, this may be considered a tie since the two values are within a defined threshold limit (e.g., 2). In that case, tie breaking code may be processed. For example, if there is a tie, a regular expression match may be performed with the following pattern: ∧*([EF])/ so that this time the winning type is captured. Here, since the response string only contains tiebreaking code for F (e.g., *F) and not E, F (Intuitive) is determined to be the tiebreaker winning component. Thus, in this non-limiting example, the user may be determined to possess the driver type of being Intuitive.

For processing of the response string to determine the expression type of the user, instances of G (People-Helping) and H (Problem-Solving) in the response string are tallied. Accordingly, if there is a tie, tiebreaker code values may also be processed, such as *G→People-Helping and *H→Problem-Solving. Thus, for the example response string 3A3C3C3C3D3C5A*A(4)1A1D8E1H(3)6F(5)1A1B1F1G(people)1B1C1F5G*F*G (statistics)1A1D1E5H(brought)1B1C1G1I1J(4)1I1J1i(2)1I(5)1J2K1L1k(4)1J1K1L(3)*J(2)1F1G1I1J(4)1B1C1F1G1J1K1L1I(2)1I1J(4)1J1K1L, the resulting tally is 9 for G and 6 for H. To process the response string, regular expression matching may be used to tally the point values for the G and H components. For example, the regular expression used for G may be /(\d+)G/, with the numbers being captured and then added up to get 9. If there is a tie, a regular expression match may also be performed with the following pattern: ∧*([GH])/ so that this time the winning type is captured.

Similarly, for processing of the response string to determine the motivation type of the user, instances of I (Compulsion), J (Connection), K (Conviction), and L (Compassion) in the response string may be scored. Thus, for the example response string 3A3C3C3C3D3C5A*A(4)1A1D8E1H(3)6F(5)1A1B1F1G(people)1B1C1F5G*F*G (statistics)1A1D1E5H(brought)1B1C1G1I1J(4)1I1J1i(2)1I(5)1J2K1L1k(4)1J1K1L(3)*J(2)1F1G1I1J(4)1B1C1F1G1J1K1L1I(2)1I1J(4)1J1K1L, the resulting tally is 5 for I, 8 for J, 5 for K, and 4 for L. Thus, the user is determined to possess a motivation type of Connection (J). In various embodiments, the response string may be processed using regular expression matching. For example, the regular expression used for J may be /(\d+)J/, with the numbers being captured and then added up to get 8. Although in this example, processing of tiebreaking code was not required, if we assumed that it was necessary, then the same regular expression match is performed, but this time ignoring the case so that values with lowercase letters are now included. Further, if there is a tie after the first tiebreaking attempt, then additional tiebreaking rules may be executed, such as deciding a victor in the tiebreaker based on a predefine priority rule, such as Compulsion<Connection<Conviction<Compassion, where Compassion has the highest priority and Compulsion has the lowest priority setting.

In various embodiments, an exemplary software tool 550 of the present disclosure may be part of a subscription service providing over a computer network to interested users. Additionally, the software tool 550 may also be integrated into other types of software platforms, such as client relationship management platforms, since the tool can be extremely useful for persons and organizations that are wanting to partner with a prospective donor to accomplish meaningful and effective giving that can be more inspiring and satisfying than conventional approaches. Accordingly, in various embodiments, the software tool 550 may comprise a plugin module (also referred to as an add-in module or widget) for integrating into various software platforms. In some embodiments, the plugin software can run in the cloud-computing environment or in a desktop application.

Embodiments of the present disclosure can be implemented in hardware, software, firmware, or a combination thereof. In an exemplary embodiment, exemplary personal giving identity logic or functionality of the present disclosure can be implemented in software or firmware that is stored in a memory and that is executed by a suitable instruction execution system. If implemented in hardware, as in an alternative embodiment, personal giving identity logic or functionality can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Embodiments of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

It should be emphasized that the above-described embodiments are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure.

1. A system comprising:
a processor of a computing device; and
a memory in communication with the processor, the memory storing program instructions, the processor operative with the program instructions to perform the operations of:
generate a graphical user interface of queries and response options for each of the queries for a user, wherein response values for the response options are embedded within the graphical user interface, wherein the response values comprises values across components of a plurality of dimensions of a personal giving identity type;
receive selections for the response options from the user;
generate a response string of selected response values based on the received response options and the embedded response values;
process the response string of selected response values to compute the personal giving identity type for the user; and
instantly display the personal giving identity type to the user.

2. The system of claim 1, wherein the personal giving identity type is displayed as part of a user-specific personal giving report on a web page or software user interface.

3. The system of claim 1, wherein the plurality of dimensions comprise a generosity personality type, a generosity expression type, a generosity driver type, and a generosity motivation type.

4. The system of claim 3, wherein each of the plurality of dimensions are composed of individual components, wherein the individual components for the generosity personality type comprises focused giving, expressive giving, disciplined giving, and considerate giving components, the individual components for the generosity expression type include people-helping and problem-solving components, the individual components for the generosity driver type include intuitive and analytic components, the individual components for the generosity motivation type include compulsion, connection, conviction, and compassion components.

5. The system of claim 4, wherein the embedded response values include a tiebreaker code for selecting between individual components that have the same point totals or have point totals within a defined threshold.

6. The system of claim 1, wherein at least one individual response value comprises values across a plurality of individual components of the same dimension.

7. The system of claim 1, wherein the queries consist of 22 queries.

8. A method comprising:
generating, by a computing device, a graphical user interface of queries and response options for each of the queries for a user, wherein response values for the response options are embedded within the graphical user interface, wherein the response values comprises values across components of a plurality of dimensions of a personal giving identity type;
receiving, by the computing device, selections for the response options from the user;
generating, by the computing device, a response string of selected response values based on the received response options and the embedded response values;
processing, by the computing device, the response string of selected response values to compute the personal giving identity type for the user; and
instantly displaying, by the computing device, the personal giving identity type to the user.

9. The method of claim 8, wherein the personal giving identity type is displayed as part of a user-specific personal giving report on a web page or software user interface.

10. The method of claim 8, wherein the plurality of dimensions comprise a generosity personality type, a generosity expression type, a generosity driver type, and a generosity motivation type.

11. The method of claim 10, wherein each of the plurality of dimensions are composed of individual components, wherein the individual components for the generosity personality type comprises focused giving, expressive giving, disciplined giving, and considerate giving components, the individual components for the generosity expression type include people-helping and problem-solving components, the individual components for the generosity driver type include intuitive and analytic components, the individual components for the generosity motivation type include compulsion, connection, conviction, and compassion components.

12. The method of claim 11, wherein the embedded response values include a tiebreaker code for selecting between individual components that have the same point totals or have point totals within a defined threshold.

13. The method of claim 8, wherein at least one individual response value comprises values across a plurality of individual components of the same dimension.

14. The method of claim 8, wherein the queries consist of 22 queries.

15. A non-transitory computer readable medium comprising machine readable instructions that, when executed by a processor of a computing device, cause the computing device to at least:
generate a graphical user interface of queries and response options for each of the queries for a user, wherein response values for the response options are embedded within the graphical user interface, wherein the response values comprises values across components of a plurality of dimensions of a personal giving identity type;
receive selections for the response options from the user;
generate a response string of selected response values based on the received response options and the embedded response values;
process the response string of selected response values to compute the personal giving identity type for the user; and
instantly display the personal giving identity type to the user.

16. The non-transitory computer readable medium of claim 15, wherein the personal giving identity type is displayed as part of a user-specific personal giving report on a web page or software user interface.

17. The non-transitory computer readable medium of claim 15, wherein the plurality of dimensions comprise a generosity personality type, a generosity expression type, a generosity driver type, and a generosity motivation type.

18. The non-transitory computer readable medium of claim 17, wherein each of the plurality of dimensions are composed of individual components, wherein the individual components for the generosity personality type comprises focused giving, expressive giving, disciplined giving, and considerate giving components, the individual components for the generosity expression type include people-helping and problem-solving components, the individual components for the generosity driver type include intuitive and analytic components, the individual components for the generosity motivation type include compulsion, connection, conviction, and compassion components.

19. The non-transitory computer readable medium of claim 18, wherein the embedded response values include a tiebreaker code for selecting between individual components that have the same point totals or have point totals within a defined threshold.

20. The non-transitory computer readable medium of claim 15, wherein at least one individual response value comprises values across a plurality of individual components of the same dimension.
